(19) United States
(12) Patent Application Publication
(10) Pub. No.: US 2026/0087681 A1
(43) Pub. Date: Mar. 26, 2026

(54) INTENT-GUIDED AND GROUNDED DOCUMENT GENERATION

(71) Applicant: ADOBE INC., SAN JOSE, CA (US)

(72) Inventors: Pritika Ramu, Bangalore (IN); Aparna Garimella, Bangalore (IN); Himanshu Maheshwari, Bengaluru (IN)

(21) Appl. No.: 18/891,558

(22) Filed: Sep. 20, 2024

(51) Int. Cl. G06T 11/00; G06F 40/186

(52) U.S. Cl. CPC G06T 11/00; G06F 40/186

(57) ABSTRACT

A method, apparatus, non-transitory computer readable medium, and system for natural language processing include obtaining an intent input including a request for information and a reference text including a source for the information. A planning instruction and an output instruction are generated based on the intent input. The planning instruction describes a document structure and an output instruction describes an output from a language generation model. A document plan for an output document with the document structure is generated, using the language generation model, based on the planning instruction. The output document is generated, using the language generation model, based on the reference text, the output instruction, and the document plan. The output document includes content from the reference text consistent with the intent input.

### BACKGROUND

The following relates generally to natural language processing (NLP), and more specifically to document generation using machine learning. NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. In some examples, generative pre-trained transformer (GPT) models are trained to understand natural language and code. GPT models provide text outputs in response to the model's inputs (e.g., a prompt from a user). Document generation refers to techniques and processes of generating documents (e.g., a summary document, an output document) based on source documents. In some cases, output documents capture content from the source documents.

### SUMMARY

The present disclosure describes systems and methods for natural language processing. Embodiments of the present disclosure include a text processing apparatus that takes an intent input and a reference text as input. The text processing apparatus generates a customized prompt for a language generation model (e.g., GPT) based on the intent input and the reference text. The prompt includes a planning instruction and an output instruction. The language generation model generates a document plan based on the planning instruction. The language generation model generates an output document based on the output instruction and the document plan. The output document includes content from the reference text that is consistent with the intent input. In some examples, the document plan includes a list of topics and the output document includes content corresponding to each topic in the list of topics. The output document is a multi-modal document including the content and an image corresponding to the content. In some cases, the image is a synthetic image generated using an image generator.

A method, apparatus, and non-transitory computer readable medium for natural language processing are described. One or more embodiments of the method, apparatus, and non-transitory computer readable medium include obtaining an intent input including a request for information and a reference text including a source for the information; generating a planning instruction and an output instruction based on the intent input, wherein the planning instruction describes a document structure and an output instruction describes an output from a language generation model; generating, using the language generation model, a document plan for an output document with the document structure based on the planning instruction; and generating, using the language generation model, the output document based on the reference text, the output instruction, and the document plan, wherein the output document includes content from the reference text consistent with the intent input.

An apparatus and method for natural language processing are described. One or more embodiments of the apparatus and method include at least one processor; at least one memory including instructions executable by the at least one processor; a prompt generation component comprising code stored in the at least one memory and configured to generate a planning instruction and an output instruction based on an intent input, wherein the planning instruction describes a document structure and an output instruction describes an output from a language generation model; and the language generation model comprising parameters stored in the at least one memory and configured to generate a document plan for an output document with the document structure based on the planning instruction, and to generate the output document based on the reference text, the output instruction, and the document plan, wherein the output document includes content from the reference text consistent with the intent input.

### BRIEF DESCRIPTION OF THE DRAWINGS

FIG. 1 shows an example of a text processing system according to aspects of the present disclosure.

FIG. 2 shows an example of a method for prompt-based document generation according to aspects of the present disclosure.

FIG. 3 shows an example of an output document according to aspects of the present disclosure.

FIG. 4 shows an example of a method for natural language processing according to aspects of the present disclosure.

FIG. 5 shows an example of a text processing apparatus according to aspects of the present disclosure.

FIG. 6 shows an example of a machine learning model according to aspects of the present disclosure.

FIG. 7 shows an example of prompt customization according to aspects of the present disclosure.

FIG. 8 shows an example of a document plan and an output document according to aspects of the present disclosure.

FIG. 9 shows an example of a machine learning model including an image generator according to aspects of the present disclosure.

FIG. 10 shows an example of prompt customization according to aspects of the present disclosure.

FIG. 11 shows an example of a document plan and an output document according to aspects of the present disclosure.

FIG. 12 shows an example of a transformer network according to aspects of the present disclosure.

FIG. 13 shows an example of a step-by-step procedure for training a machine learning model according to aspects of the present disclosure.

FIG. 14 shows an example of images using during training according to aspects of the present disclosure.

FIG. 15 shows an example of a computing device for natural language processing according to aspects of the present disclosure.

### DETAILED DESCRIPTION

The present disclosure describes systems and methods for natural language processing. Embodiments of the present disclosure include a text processing apparatus that takes an intent input and a reference text as input. The text processing apparatus generates a customized prompt for a language generation model (e.g., GPT) based on the intent input and the reference text. The prompt includes a planning instruction and an output instruction. The language generation model generates a document plan based on the planning instruction. The language generation model generates an output document based on the output instruction and the document plan. The output document includes content from the reference text that is consistent with the intent input. In some examples, the document plan includes a list of topics and the output document includes content corresponding to each topic in the list of topics. The output document is a multi-modal document including the content and an image corresponding to the content. In some cases, the image is a synthetic image generated using an image generator.

Document generation is the process of analyzing one or more source documents to produce an output document that references or includes content from the one or more source documents. Machine learning models have been used in document processing tasks, such as generating content using sequence-to-sequence generation models. However, conventional machine learning models depend on a prompt from a user and lack a high-level plan for the outline of the document. In some cases, a user-provided prompt is simplistic and not customized enough to enable language models to generate content to the user's satisfaction. Additionally, language models are pre-trained on documents from the Internet that are not relevant to a particular theme at hand and may output irrelevant information in the output document.

Embodiments of the present disclosure include a text processing apparatus that takes an intent input and a reference text as input. In some examples, a user wants to create a section in an article using the text processing apparatus. The section is about “Virginia: State Symbols”. Here, the intent input is “Virginia: State Symbols”. The reference text includes one or more reference articles. Accordingly, given an intent input (e.g., a section title) and the one or more reference documents, the text processing apparatus generates section content in a document grounded on the one or more reference documents.

In some embodiments, the text processing apparatus generates a multi-modal output document (e.g., section content along with images) based on an intent input (e.g., section titles) and grounded on one or more reference articles. The text processing apparatus is not dependent on parallel training data, and instead leverages a language generation model (e.g., GPT-3.5, LLaMa) using customized prompts. A prompt generation component of the text processing apparatus generates a prompt for the language generation model based on the intent input and the reference text. The prompt includes a planning instruction and an output instruction.

In some cases, the text processing apparatus involves a plan-and-write (PAW) prompting method comprising steps of obtaining a document title, a section title, and relevant reference sentences as inputs; and using a language generation model to first generate a document plan for the document section, and then a coherent section based on the document plan.

In some cases, the text processing apparatus involves a multi-modal plan-and-write (MM-PAW) prompting method comprising steps of obtaining a document title, a section title, and relevant reference sentences; using a language generation model to generate a multi-modal plan including textual topics and image description for the document section; and using the plan to generate a coherent section and corresponding images. In some examples, an image generator generates a synthetic image based on the image description. The image generator includes a text-to-image generation model. The output document includes a multi-media document comprising the synthetic image.

For example, a customizable prompt includes an agent specification section (“You are a friendly, expert, and helpful agent helping a content creator write coherent sections to create a document on Virginia”). The customizable prompt includes an input information section (“You will be given the heading of the section you are supposed to write, and the title of the document under which this section should occur. Additionally, you will be given some initial context, and reference sentences to generate the section”). The customizable prompt includes a task orientation and constraint implementation section (“First, come up with a plan with various topics to be discussed to write a section on State Symbols. Then write a section using the generated plan by filling it with the reference sentences in more than 224 and less than 336 words. Do not use your own knowledge and only rely on reference sentences. Only output the final section content and nothing else. Give image descriptions that are suitable for the section. Only output the final section content and image description and nothing else”). Additionally, the customizable prompt includes an input information section (“Section heading: Virginia; Document title: State Symbols; Initial content: Virginia's history begins with several . . . ; “Reference sentences: . . . ”). For example, a generated document plan is “1. State Seal; 2. State Motto; 3. State Flag; 4. State Nicknames; 5. State Songs; 6. State Animals”.

The present disclosure describes systems and methods that improve on conventional text processing models by providing more accuracy over generated content related to an intent input. For example, users provide an intent input and a reference text. The machine learning model described in the present disclosure generates an output document comprising content from the reference text consistent with the intent input. The machine learning model retrieves relevant content from the reference text based on the intent input and uses a language generation model to generate intermediate plans to extract useful content from the retrieved sentences to generate a coherent final section. Some embodiments achieve improved accuracy by inserting the intent input and the reference text into a prompt template such that the prompt includes a planning instruction and an output instruction. Then the language generation model generates a document plan based on the planning instruction and subsequently generates an output document based on the output instruction and the document plan.

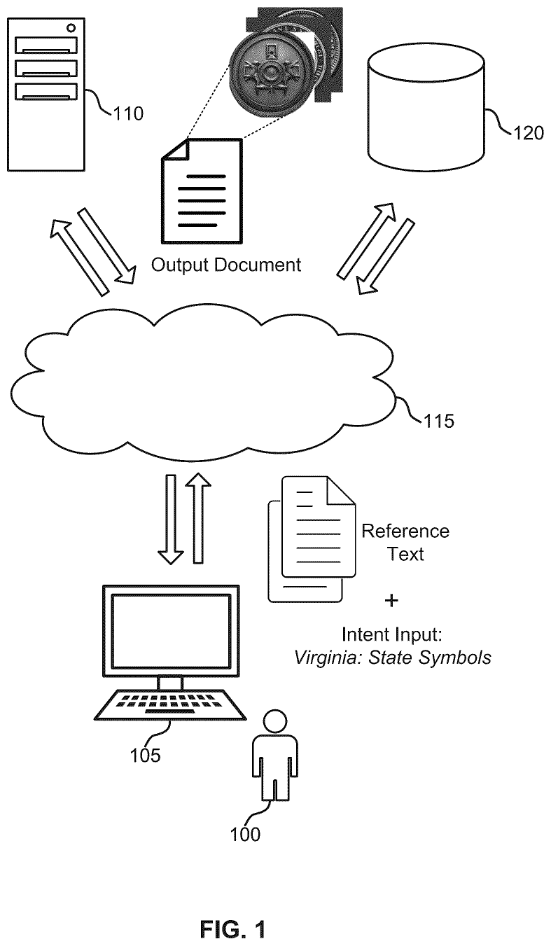

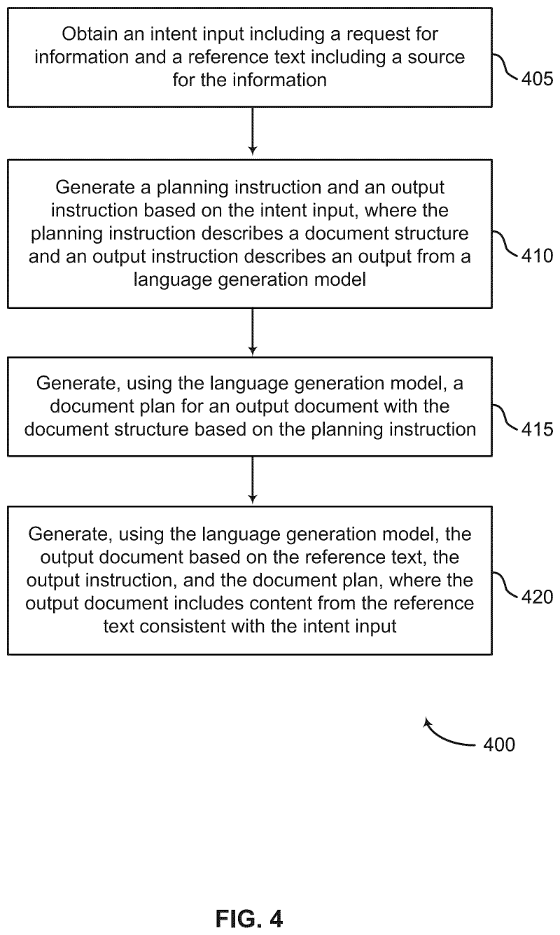

In some examples, a text processing apparatus based on the present disclosure obtains an intent input and reference text (e.g., one or more reference articles), and then generates a document plan and an output document. The output document includes content from the reference text consistent with the intent input. Examples of application in intent-guided and grounded document generation context are provided with reference to FIGS. 1-3. Details regarding the architecture of an example text processing system are provided with reference to FIGS. 1 and 5-12. Details regarding methods of natural language processing are provided with reference to FIG. 4.

### Natural Language Processing

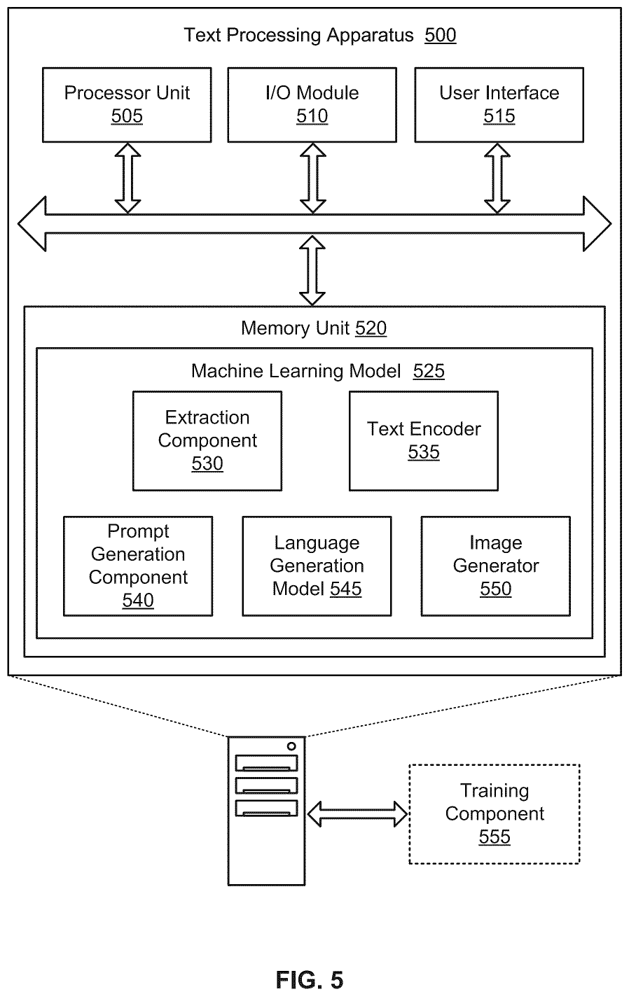

FIG. 1 shows an example of a text processing system according to aspects of the present disclosure. The example shown includes user 100, user device 105, text processing apparatus 110, cloud 115, and database 120. Text processing apparatus 110 is an example of, or includes aspects of, the corresponding element described with reference to FIG. 5.

In an example shown in FIG. 1, reference text (e.g., reference articles in docx, PDF, HTML format) and an intent input (e.g., Virginia: State Symbols) are provided by user 100 and transmitted to text processing apparatus 110, e.g., via user device 105 and cloud 115. The reference text includes multi-modal content (text, images, tables, charts, etc.). An extraction component is used to extract content from the reference articles.

Text processing apparatus 110 receives the intent input and the reference text. Text processing apparatus 110 generates a prompt for a language generation model based on the intent input and the reference text. The prompt includes a planning instruction and an output instruction. Text processing apparatus 110 generates, using the language generation model, a document plan and (optional) image descriptions based on the planning instruction. The document plan is not shown to user 100, but the document plan is used internally for subsequent content generation. Text processing apparatus 110 generates, using the language generation model, an output document based on the output instruction and the document plan. The output document includes content from the reference text consistent with the intent input.

In some cases, the document plan includes multiple topics (or topic descriptions) based on the intent input and the reference text. Additionally, text processing apparatus 110 retrieves content from the reference articles via an extraction component (or a retrieval model). The retrieved content is then placed in the output document corresponding to each of the topics in the document plan. In some examples, the wording of the topics in the output document may be different from the section titles in the reference articles.

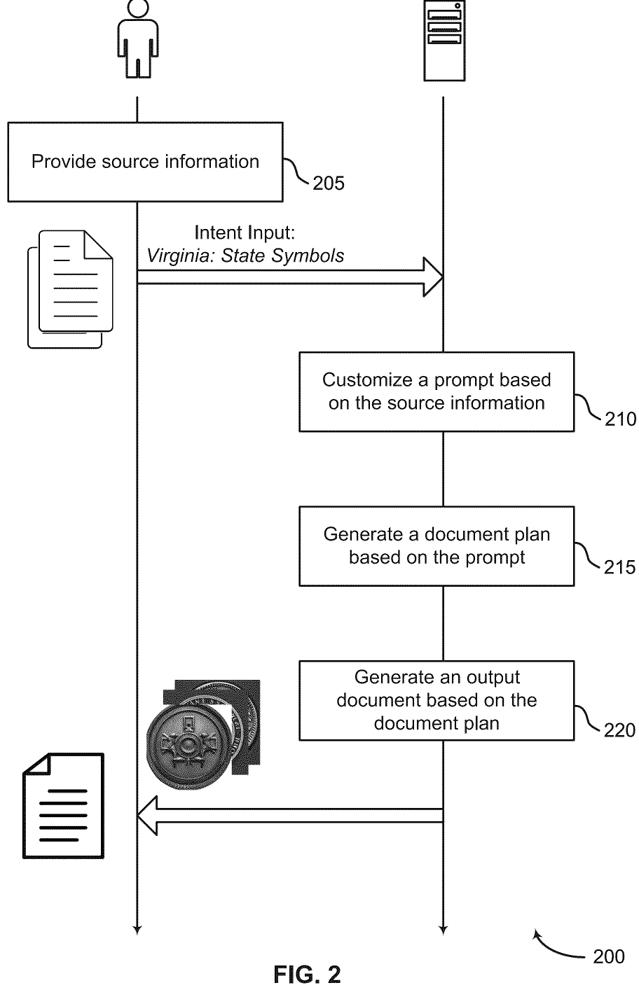

Text processing apparatus 110 generates, using an image generator, synthetic images based on the image descriptions and places the synthetic images to accompany a topic or section content in the output document. Text processing apparatus 110 returns the output document to user 100 via cloud 115 and user device 105. The output document is of a format indicated by a file extension such as .docx, .PDF, etc., and includes visually rich multi-modal content. In some examples, the output document spans multiple pages in length and is relatively concise compared to the reference articles (i.e., source document(s)). The method and process of using text processing apparatus 110 is further described with reference to FIG. 2.

User device 105 may be a personal computer, laptop computer, mainframe computer, palmtop computer, personal assistant, mobile device, or any other suitable processing apparatus. In some examples, user device 105 includes software that incorporates a text processing application (e.g., a document generator, a text editing tool). In some examples, the text processing application on user device 105 may include functions of text processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Text processing apparatus 110 includes a computer-implemented network comprising an extraction or a text retrieval component, a text encoder, a prompt generation component, a language generation model, and an image generator. Text processing apparatus 110 may also include a processor unit, a memory unit, an I/O module, and a user interface. A training component may be implemented on an apparatus other than text processing apparatus 110. The training component is used to train a language generation model (e.g., a pre-trained model). Additionally, text processing apparatus 110 can communicate with database 120 via cloud 115. In some cases, the architecture of the text processing network is also referred to as a network, a machine learning model, or a network model. Further detail regarding the architecture of text processing apparatus 110 is provided with reference to FIGS. 5-12. Further detail regarding the operation of text processing apparatus 110 is provided with reference to FIGS. 2 and 4.

In some cases, text processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., training dataset, reference articles, parameters of a network model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for prompt-based document generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, a user provides source information. In some cases, the operations of this step refer to, or may be performed by, a user 100 as described with reference to FIG. 1.

In some examples, a user provides one or more reference articles identifying sources of information to be included in an output multi-modal document (e.g. an output document including different modalities of information such as text and images). For example, the user provides a list of reference articles containing information about the State of Virginia, and an intent input specifying the user's intent to generate an output document that is relevant to Virginia and state symbols. In some cases, the user additionally provides initial context to set the ground for one or more output sections in the output multi-modal document.

At operation 210, the system customizes a prompt based on the source information. In some cases, the operations of this step refer to, or may be performed by, a text processing apparatus as described with reference to FIGS. 1 and 5.

In some embodiments, a text processing apparatus with reference to FIG. 5 encodes text from the reference articles and the intent input into high-dimensional encodings using a transformer network. In some cases, relevant text from the reference articles is retrieved based on a similarity between the text encoding and the intent encoding.

In some examples, a customized prompt may include agent specification, task orientation, constraint implementation, a trigger phrase, etc. In some examples, the trigger phrase includes the phrase “come up with a plan with various topics to be discussed to write a section on [section name].” In some cases of the trigger phrase, [section name] may be replaced by a section name which corresponds to the reference articles and/or intent input. The customized prompt is input to a language generation model (e.g., GPT, LLaMa) to generate an output document.

At operation 215, the system generates a document plan based on the prompt. In some cases, the operations of this step refer to, or may be performed by, a text processing apparatus as described with reference to FIGS. 1 and 5.

The prompt is input to a language generation model (e.g., GPT, LLaMa). The model generates a document plan based on the prompt. For example, the document plan includes section topics or topic descriptions that are relevant to Virginia and state symbols, so the model generates a document with content relating to the section topics from the document plan (i.e., based on the intent input from the user).

At operation 220, the system generates an output document based on the document plan. In some cases, the operations of this step refer to, or may be performed by, a text processing apparatus as described with reference to FIGS. 1 and 5.

In some cases, the customized prompt comprises multiple sections including agent specification, task orientation, and constraint implementation, and the language generation model generates an output document based on the customized prompt (e.g., a multi-modal document comprising content sections and corresponding images). The output document is based on the reference articles and the intent input. The output document also follows an ordering of topics listed in the document plan.

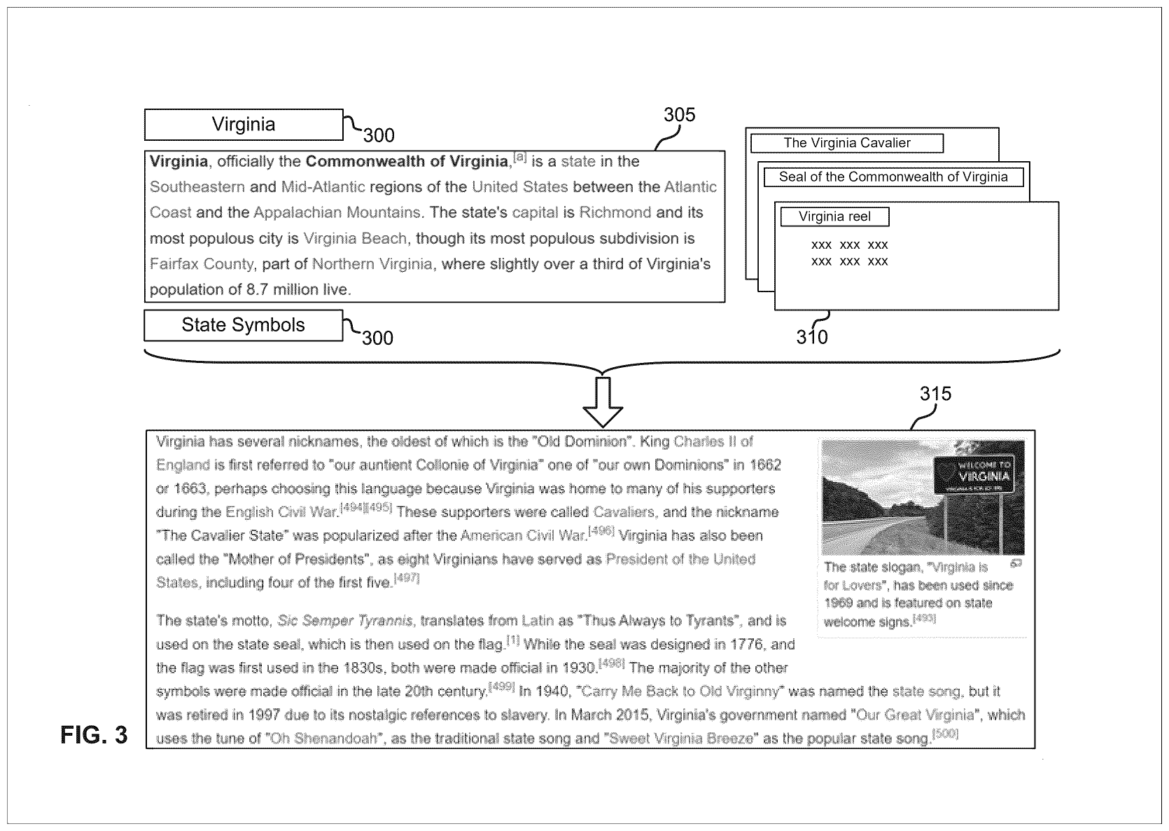

FIG. 3 shows an example of an output document 315 according to aspects of the present disclosure. The example shown includes intent input 300, initial context 305, reference text 310, and output document 315.

In some examples, intent input 300, initial context 305, and reference text 310 are provided by a user and transmitted to text processing apparatus 500 as described with reference to FIG. 5. Reference text 310 contains source information for generating output document 315 (e.g., a multi-modal document). In some examples, reference text 310 contains one or more reference articles. Intent input 300 includes a phrase that indicates a user intent for the target content in output document 315. In some cases, intent input 300 is used to guide an extraction component to retrieve relevant information from the reference text 310. In an example shown in FIG. 3, intent input 300 includes “Virginia” and “State Symbols” (i.e., state symbols for Virginia). The initial context 305 provides information regarding desired stylistic restraints in output document 315 based on the input.

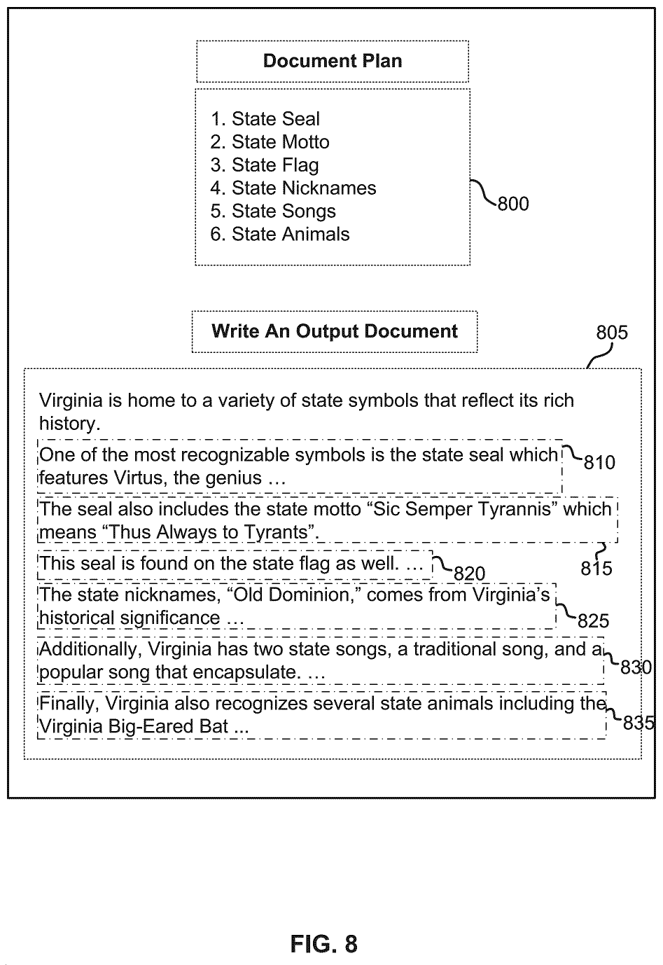

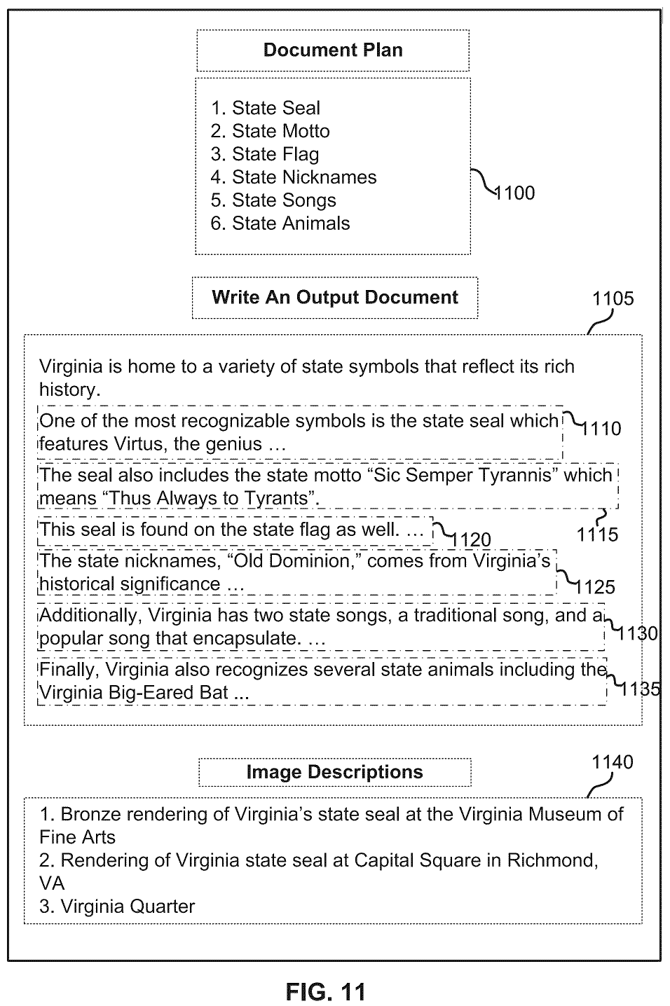

In an embodiment, text processing apparatus 500 generates output document 315 based on intent input 300, initial context 305, and reference text 310. In some cases, output document 315 includes text from reference text 310, where the text is related to the intent input 300 and initial context 305. Output document 315 is an example of, or includes aspects of, the corresponding element described with reference to FIGS. 8 and 11.

In some examples, a user has access to a few reference articles and intends to use the reference content to create a draft for a section. That is, given intent input 300 (e.g., a section title) and reference text 310 (e.g., one or more reference documents), text processing apparatus 500 generates section content in a document grounded on the reference text 310.

FIG. 4 shows an example of a method 400 for natural language processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains an intent input including a request for information and a reference text including a source for the information. In some cases, the operations of this step refer to, or may be performed by, a machine learning model as described with reference to FIGS. 5, 6, and 9.

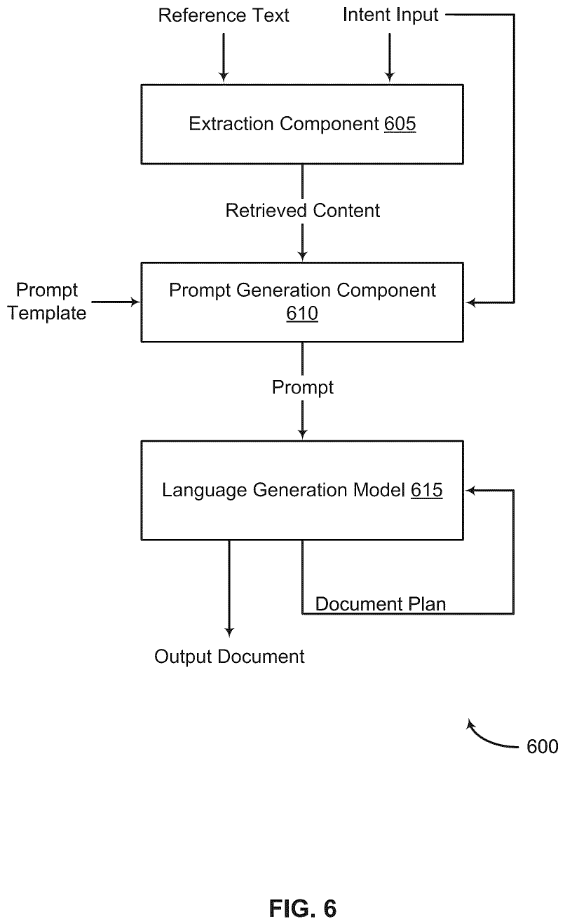

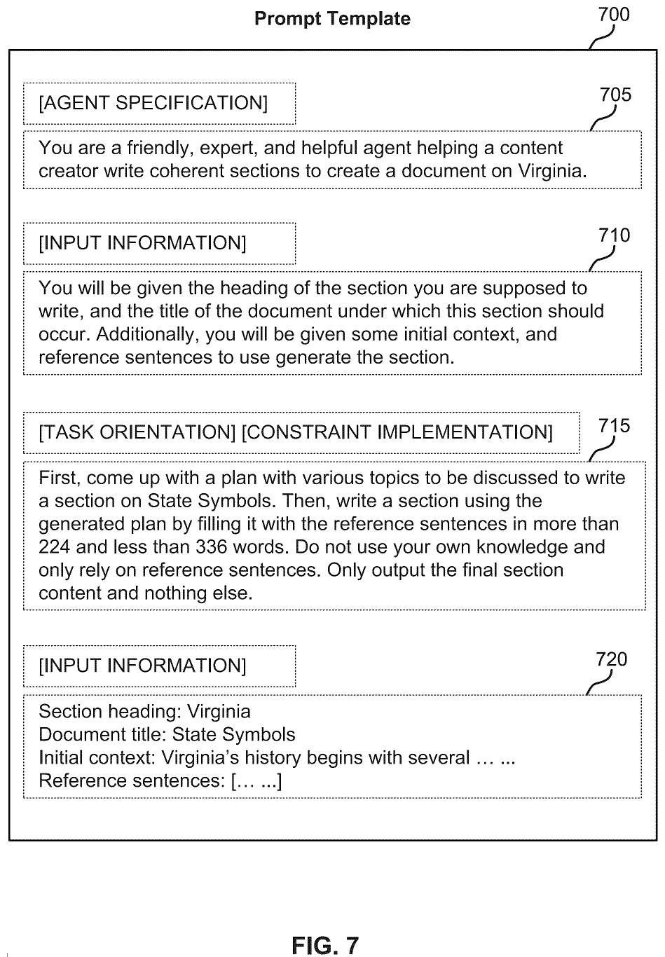

In an embodiment, a user-specified intent is input to an extraction component (or a text retrieval model) to retrieve a list of sentences related to the intent input. The output from the extraction component includes the list of sentences from reference text (e.g., one or more reference articles) relevant to the user-specified intent (i.e., the intent input is used to retrieve content from the reference text). The reference text provides a source for the information and accordingly an output document in response to a request for the information is based in part on the reference text. The list of sentences from the reference text is then used for content generation. In some examples, the intent input includes a document title, a section heading, or both. An example of an intent input is “Virgina: State Symbols” where “Virginia” is a section heading and “State Symbols” is a document title. A text encoder (e.g., a transformer-based sentence encoder) is used to encode the sentences from the reference articles and the intent input. The extraction component retrieves top k sentences (or top k paragraphs) from the reference articles based on cosine similarity. In some cases, the intent input is inserted into a prompt template via prompt generation component 610 as described in FIG. 6. Prompt generation component 610 then generates a customized prompt (or a prompt for brevity). The intent input is part of an input information section in the customized prompt (referring to an example in FIG. 7).

At operation 410, the system generates a planning instruction and an output instruction based on the intent input, where the planning instruction describes a document structure and an output instruction describes an output from a language generation model. In some cases, the operations of this step refer to, or may be performed by, a prompt generation component as described with reference to FIGS. 5, 6, and 9.

In some examples, a planning instruction describes a document structure for an output document. An example of a planning instruction includes “First, come up with a plan with various topics to be discussed to write a section on State Symbols. Then, write a section using the generated plan by filling it with the reference sentences in more than 224 and less than 336 words”. The planning instruction in the customized prompt comprises a sequence of instructions for a language generation model to follow. The planning instruction includes, but is not limited to, an instruction to generate a document plan, an instruction to generate a section with content based on the document plan, an instruction about word count range, etc.

In some examples, an output instruction describes a desired output from the language generation model. An example of an output instruction includes “Do not use your own knowledge and only rely on reference sentences. Only output the final section content and nothing else”. The output instruction is used to guide the language generation model to generate content based exclusively on the reference text mentioned in operation 405 above. Additionally, the output instruction guides the language generation model to output an output document without the document plan (i.e., the document plan is an intermediate output internally but it is not presented to users).

In some examples, a prompt generation component (as described with reference to FIGS. 5-6) obtains a prompt template and inserts the intent input and the reference text into the prompt template. The prompt specifies a structure of the output document. The prompt includes an instruction not to output the document plan. The prompt generation component generates a customized prompt that is fed to a language generation model. The customized prompt provides guidelines or directives for the language generation model. Because of these directives and guidelines, an output document is grounded on reference sentences and the language generation model refrains from using its internal knowledge.

At operation 415, the system generates, using the language generation model, a document plan for an output document with the document structure based on the planning instruction. In some cases, the operations of this step refer to, or may be performed by, a language generation model as described with reference to FIGS. 5, 6, and 9.

In some examples, a document plan includes a set of topics or topic descriptions. The document plan is generated based on the intent input, initial context, and the reference text. An example of a document plan is described with reference to FIG. 8. In the example, the document plan includes six topics “State Seal”, “State Motto”, “State Flag”, “State Nicknames”, “State Songs”, and “State Animals”. An output document is generated based on the document plan.

Providing reference sentences to the language generation model may not ensure a structured order of topics in the generated content, nor does it guarantee that all the reference sentences are relevant to the intent input. In an embodiment, the customized prompt from operation 410 is used to prompt the language generation model to devise a document plan before generating the actual content. The objectives of the customized prompt include at least (1) generating well-structured content for a given intent; and (2) encompassing key topics associated with the intent input, ensuring comprehensive coverage.

At operation 420, the system generates, using the language generation model, the output document based on the reference text, the output instruction, and the document plan, where the output document includes content from the reference text consistent with the intent input. In some cases, the operations of this step refer to, or may be performed by, a language generation model as described with reference to FIGS. 5, 6, and 9. In some examples, an output document includes content that expands on each topic of the set of topics in the document plan. The section content for each topic is based on the reference text (e.g., the one or more reference articles) and hence model's own knowledge is not used when generating the output document.

The input to the prompt generation component includes retrieved sentences from the extraction component. In some examples, an output from the language generation model includes a coherent, fluent, and grounded paragraph. The output paragraph forms the textual part of content expansion. This process of generating text using retrieval may be referred to as retrieval augmented generation. In some examples, the language generation model includes GPT-3.5 turbo, however embodiments of the present disclosure can use any types of large language models (LLM). In the output document, the reference sentences flow coherently and fluently into one or more paragraphs. The output document has sufficient coverage of topics corresponding to the given user-specified intent.

In FIGS. 1-4, a method, apparatus, and non-transitory computer readable medium for natural language processing are described. One or more embodiments of the method, apparatus, and non-transitory computer readable medium include obtaining an intent input and a reference text; generating a prompt for a language generation model based on the intent input and the reference text, wherein the prompt includes a planning instruction and an output instruction; generating, using the language generation model, a document plan based on the planning instruction; and generating, using the language generation model, an output document based on the output instruction and the document plan, wherein the output document includes content from the reference text consistent with the intent input.

In some examples, the intent input comprises a document title, a section heading, or both. In some examples, the reference text includes a plurality of sentences from a plurality of different source documents.

Some examples of the method, apparatus, and non-transitory computer readable medium further include encoding the intent input and the reference text to obtain an intent encoding and a text encoding, respectively. Some examples further include comparing the intent encoding and the text encoding, wherein the reference text is selected based on the comparison.

Some examples of the method, apparatus, and non-transitory computer readable medium further include obtaining a prompt template. Some examples further include inserting the intent input and the reference text into the prompt template.

In some examples, the prompt specifies a structure of the output document. In some examples, the prompt includes an instruction not to output the document plan. In some examples, the document plan includes a list of topics and the output document includes content corresponding to each topic in the list of topics. Some examples of the method, apparatus, and non-transitory computer readable medium further include autoregressively generating text of the output document.

Some examples of the method, apparatus, and non-transitory computer readable medium further include generating, using the language generation model, an image description based on the prompt. Some examples further include obtaining an image based on the image description, wherein the output document comprises a multi-media document including the image. Some examples of the method, apparatus, and non-transitory computer readable medium further include obtaining a document template. Some examples further include inserting the content into the document template.

### Network Architecture

FIG. 5 shows an example of a text processing apparatus 500 according to aspects of the present disclosure. The example shown includes text processing apparatus 500, processor unit 505, I/O module 510, user interface 515, memory unit 520, machine learning model 525, and training component 555. Text processing apparatus 500 is an example of, or includes aspects of, the corresponding element described with reference to FIG. 1.

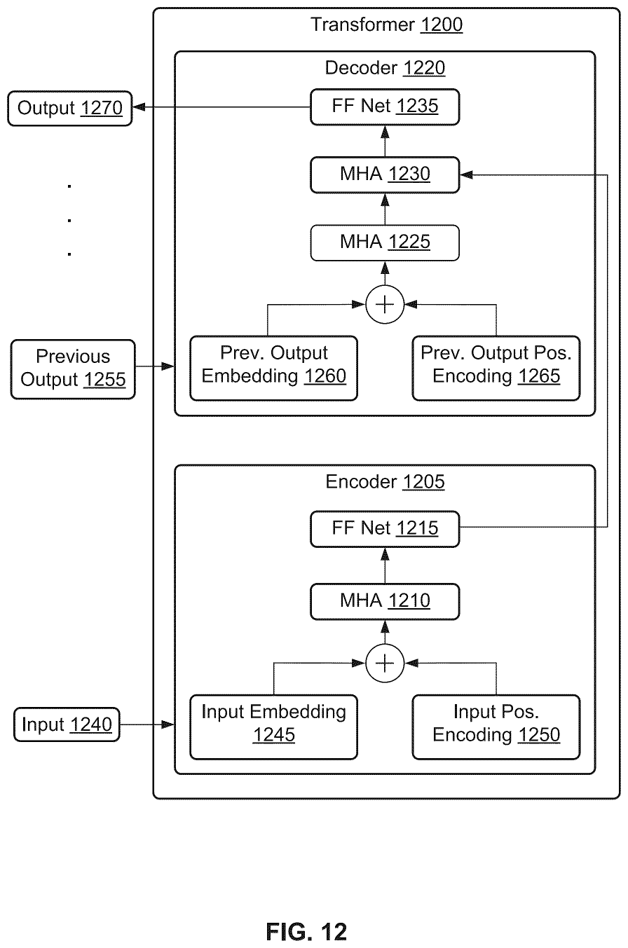

Text processing apparatus 500 may include an example of, or aspects of, the transformer network described with reference to FIG. 12. In some embodiments, text processing apparatus 500 includes processor unit 505, I/O module 510, user interface 515, memory unit 520, machine learning model 525, and training component 555. Training component 555 updates parameters of the machine learning model 525 stored in memory unit 520. In some examples, the training component 555 is located outside the text processing apparatus 500.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

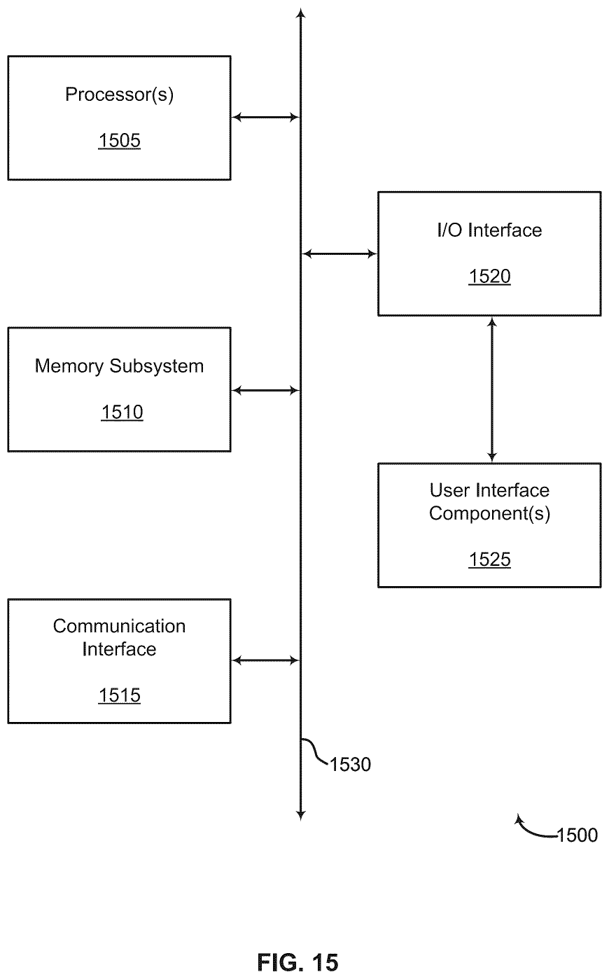

In some cases, processor unit 505 is configured to operate a memory array using a memory controller. In other cases, a memory controller is integrated into processor unit 505. In some cases, processor unit 505 is configured to execute computer-readable instructions stored in memory unit 520 to perform various functions. In some aspects, processor unit 505 includes special purpose components for modem processing, baseband processing, digital signal processing, or transmission processing. According to some aspects, processor unit 505 comprises one or more processors described with reference to FIG. 15.

Memory unit 520 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

In some cases, memory unit 520 includes a basic input/output system (BIOS) that controls basic hardware or software operations, such as an interaction with peripheral components or devices. In some cases, memory unit 520 includes a memory controller that operates memory cells of memory unit 520. For example, the memory controller may include a row decoder, column decoder, or both. In some cases, memory cells within memory unit 520 store information in the form of a logical state. According to some aspects, memory unit 520 is an example of the memory subsystem 1510 described with reference to FIG. 15.

According to some aspects, text processing apparatus 500 uses one or more processors of processor unit 505 to execute instructions stored in memory unit 520 to perform functions described herein. For example, text processing apparatus 500 may obtain an intent input and a reference text; generate a prompt for a language generation model based on the intent input and the reference text, where the prompt includes a planning instruction and an output instruction; generate, using the language generation model, a document plan based on the planning instruction; and generate, using the language generation model, an output document based on the output instruction and the document plan, where the output document includes content from the reference text consistent with the intent input.

The memory unit 520 may include a machine learning model 525 trained to obtain an intent input and a reference text; generate a prompt for a language generation model based on the intent input and the reference text, where the prompt includes a planning instruction and an output instruction; generate, using the language generation model, a document plan based on the planning instruction; and generate, using the language generation model, an output document based on the output instruction and the document plan, where the output document includes content from the reference text consistent with the intent input. For example, machine learning model 525 is a pre-trained model and performs inferencing operations as described with reference to FIGS. 2 and 4.

In some embodiments, machine learning model 525 is an Artificial neural network (ANN) such as the transformer network described with reference to FIG. 12. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 525 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

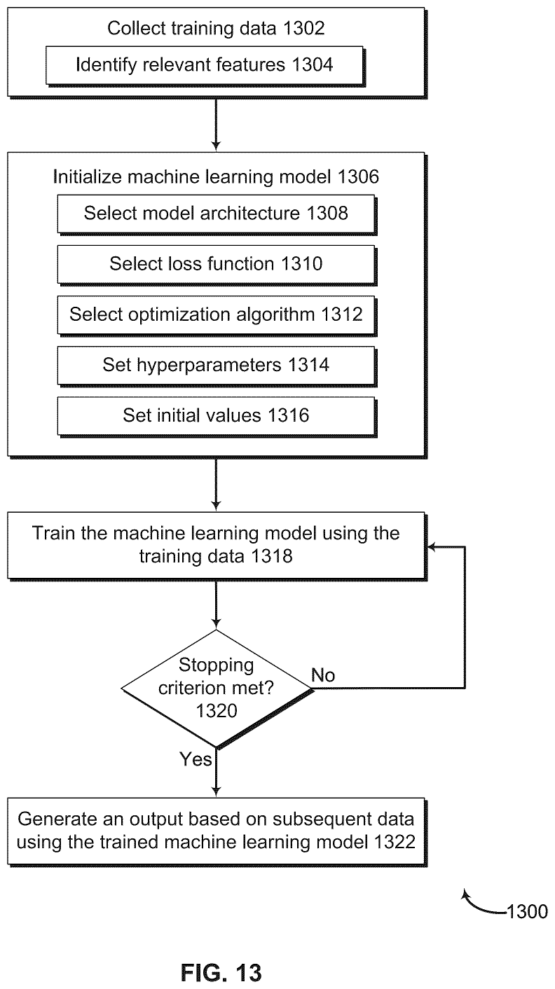

Training component 555 may train the machine learning model 525. For example, parameters of the machine learning model 525 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 12-13). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 525 can be used to make predictions on new, unseen data (i.e., during inference).

I/O module 510 receives inputs from and transmits outputs of the text processing apparatus 500 to other devices or users. For example, I/O module 510 receives inputs for the machine learning model 525 and transmits outputs of the machine learning model 525. According to some aspects, I/O module 510 is an example of the I/O interface 1520 described with reference to FIG. 15.

In some examples, I/O module 510 includes a user interface 515. The user interface 515 may enable a user to interact with a device. In some embodiments, the user interface 515 may include an audio device, such as an external speaker system, an external display device such as a display screen, or an input device (e.g., remote control device interfaced with the user interface 515 directly or through an I/O controller module). In some cases, a user interface 515 may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments, machine learning model 525 obtains an intent input and a reference text. In some examples, the intent input includes a document title, a section heading, or both. In some examples, the reference text includes a set of sentences from a set of different source documents.

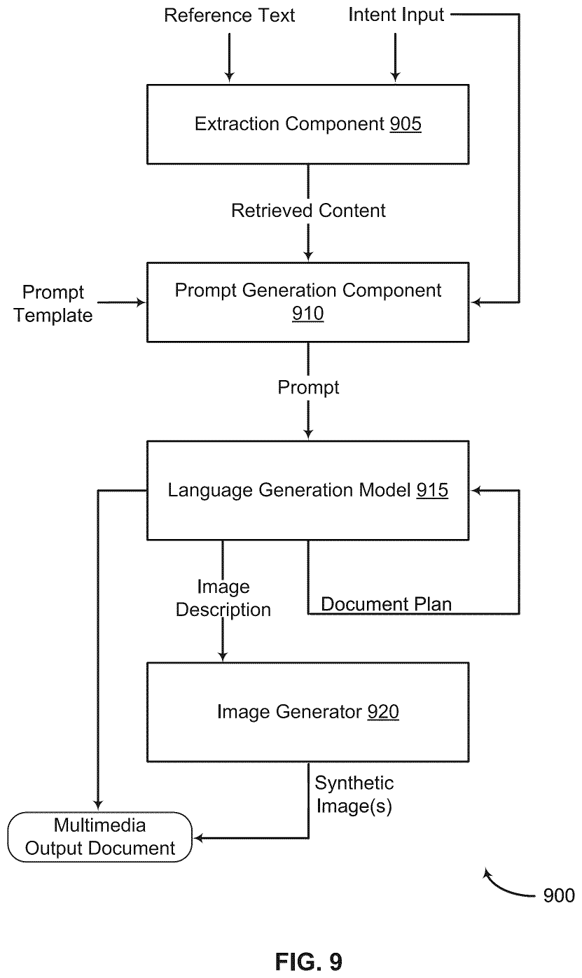

Machine learning model 525 is an example of, or includes aspects of, the corresponding element described with reference to FIGS. 6 and 9. In one embodiment, machine learning model 525 includes extraction component 530, text encoder 535, prompt generation component 540, language generation model 545, and image generator 550.

According to some embodiments, extraction component 530 is configured to extract sentences from a set of different source documents. The reference text includes the extracted sentences. Extraction component 530 is an example of, or includes aspects of, the corresponding element described with reference to FIGS. 6 and 9.

According to some embodiments, text encoder 535 encodes the intent input and the reference text to obtain an intent encoding and a text encoding, respectively. In some examples, machine learning model 525 compares the intent encoding and the text encoding, where the reference text is selected based on the comparison.

According to some embodiments, prompt generation component 540 generates a prompt for a language generation model 545 based on the intent input and the reference text, where the prompt includes a planning instruction and an output instruction. In some examples, prompt generation component 540 obtains a prompt template. Prompt generation component 540 inserts the intent input and the reference text into the prompt template. In some examples, the prompt specifies a structure of the output document. In some examples, the prompt includes an instruction not to output the document plan. Prompt generation component 540 is an example of, or includes aspects of, the corresponding element described with reference to FIGS. 6 and 9.

According to some embodiments, language generation model 545 generates a document plan based on the planning instruction. In some examples, language generation model 545 generates an output document based on the output instruction and the document plan, where the output document includes content from the reference text consistent with the intent input. In some examples, the document plan includes a list of topics and the output document includes content corresponding to each topic in the list of topics. In some examples, language generation model 545 autoregressively generates text of the output document.

In some examples, language generation model 545 generates an image description based on the prompt. Machine learning model 525 obtains an image based on the image description, where the output document includes a multi-media document including the image. In some examples, language generation model 545 obtains a document template. In some examples, language generation model 545 inserts the content into the document template or in the place of the document template.

In some examples, language generation model 545 (including parameters stored in the at least one memory such as memory unit 520) generates a document plan based on the planning instruction, and generates an output document based on the output instruction and the document plan, where the output document includes content from the reference text consistent with the intent input. In some examples, language generation model 545 includes a transformer network. Language generation model 545 is an example of, or includes aspects of, the corresponding element described with reference to FIGS. 6 and 9.

According to some embodiments, image generator 550 generates a synthetic image based on an image description, where the output document comprises a multi-media document including the synthetic image. Image generator 550 is an example of, or includes aspects of, the corresponding element described with reference to FIG. 9.

FIG. 6 shows an example of a machine learning model 600 according to aspects of the present disclosure. In one embodiment, machine learning model 600 includes extraction component 605, prompt generation component 610, and language generation model 615. Machine learning model 600 is an example of, or includes aspects of, the corresponding element described with reference to FIGS. 5 and 9.

In an embodiment, machine learning model 600 is used for text grounded content generation. A user provides an intent input which can be a document title or a section title. Extraction component 605 retrieves textual content from one or more reference documents relevant to the user intent. The retrieved sentences from reference documents, the intent input, and a prompt template are fed to prompt generation component 610 to obtain a customized prompt. The customized prompt is input to language generation model 615 (e.g., GPT) to generate a document plan of the content to be generated along with the content that is generated.

In an embodiment, reference text and an intent input are input to extraction component 605. Extraction component 605 outputs retrieved content based on the reference text and the intent input. In some cases, extraction component 605 may be referred to as a retrieval model. Extraction component 605 is an example of, or includes aspects of, the corresponding element described with reference to FIGS. 5 and 9.

The retrieved content and a prompt template are input to prompt generation component 610 to obtain a customized prompt. The prompt is used to guide language generation model 615 in grounded document generation. In some examples, the customized prompt includes agent specification, input information, task orientation, constraint implementation, etc. In some examples, machine learning model 600 inserts the intent input and the reference text into the prompt template. The prompt specifies a structure of an output document. In some examples, the prompt includes an instruction not to output a document plan. Prompt generation component 610 is an example of, or includes aspects of, the corresponding element described with reference to FIGS. 5 and 9.

Language generation model 615 generates a document plan based on the customized prompt. The document plan includes a list of topics and the output document includes content corresponding to each topic in the list of topics. Subsequently the document plan is used to generate the output document. The output document includes content from the reference text consistent with the intent input. In some cases, the output document is a multi-modal document containing grounded media items based on the intent input and reference text. Language generation model 615 is an example of, or includes aspects of, the corresponding element described with reference to FIGS. 5 and 9.

In some examples, language generation model 615 adopts a planning-based prompting method for document generation conditioned on the given intent and references. In some cases, the planning-based method may be referred to as plan-and-write prompting method. A language model is prompted to first generate a plan for the document section, and then the plan is used to generate a coherent section given the reference documents.

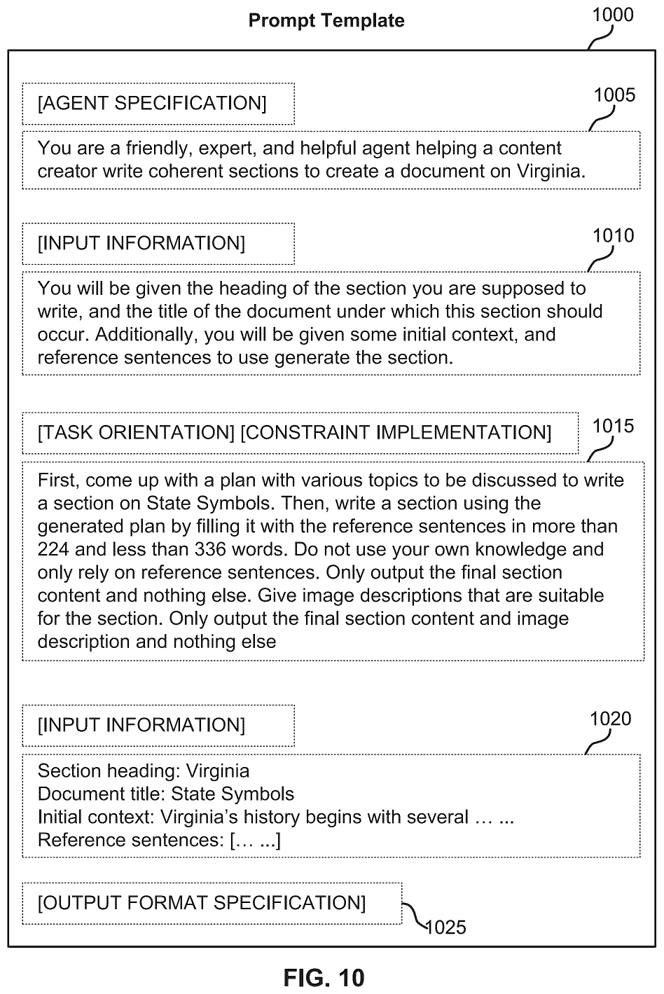

FIG. 7 shows an example of prompt 700 customization according to aspects of the present disclosure. The example shown includes prompt 700, first section 705, second section 710, third section 715, and fourth section 720. Prompt 700 is an example of, or includes aspects of, the corresponding element described with reference to FIG. 10.

FIG. 7 illustrates an example of a populated prompt that is fed to language generation model 615 described with reference to FIG. 6. In an embodiment, prompt 700 includes first section 705, second section 710, third section 715, and fourth section 720.

First section 705 relates to agent specification which provides guidelines and directives for the language generation model 615 to assume a friendly, expert, and helpful character. The objective of specifying these character traits is to let a user craft a systematically structured section for an output document.

Second section 710 relates to input information which indicates that a document title, section heading(s) and initial context are provided to set the ground for the section, and a selection of reference sentences for generating section content are fed to language generation model 615.

Third section 715 relates to task orientation which indicates that an objective of language generation model 615 is delineated in a two-fold process. First, language generation model 615 is tasked to formulate a document plan for the section to be generated, illustrating various topics to be the subject of generated content. The document plan serves as a directive for structuring the section. Second, language generation model 615 is tasked to compose the section by using the pre-established document plan and integrating the reference sentences extracted from the reference text (e.g., one or more different source documents.

Fourth section 720 relates to constraint implementation. The prompt layout imposes certain restrictions, for example, the generated content needs to comply with a pre-determined word count range, language generation model 615 is prompted to rely strictly on the provided reference sentences and to refrain from relying on the model's own knowledge. The agent (or the model) is instructed to generate exclusively the final content for the segment, avoiding any surplus output. In some examples, a trigger phrase in prompt 700 to achieve the objective for content generation is, for example, “come up with a plan with various topics to be discussed to write a section on [section name].”

First section 705 is an example of, or includes aspects of, the corresponding element described with reference to FIG. 10. Second section 710 is an example of, or includes aspects of, the corresponding element described with reference to FIG. 10. Third section 715 is an example of, or includes aspects of, the corresponding element described with reference to FIG. 10. Fourth section 720 is an example of, or includes aspects of, the corresponding element described with reference to FIG. 10.

FIG. 8 shows an example of a document plan 800 and an output document 805 according to aspects of the present disclosure. The example shown includes document plan 800 and output document 805.

In an embodiment, language generation model 615 (with respect to FIG. 6) generates document plan 800 and output document 805. The document plan 800 includes a list of topics to be covered and elaborated on in output document 805. The output document 805 includes content corresponding to each topic in the list of topics.

For example, document plan 800 relates to Virginia state symbols and includes “state seal”, “state motto”, “state flag”, “state nicknames”, “state songs”, and “state animals”. Output document 805 includes content corresponding to each topic in the list of topics following an ordering of topics in the list. That is, language generation model 615 expands on the list of topics to obtain content corresponding to each topic. Document plan 800 is an example of, or includes aspects of, the corresponding element described with reference to FIG. 11.

In an example, output document 805 includes first content 810, second content 815, third content 820, fourth content 825, fifth content 830, and sixth content 835. First content 810, second content 815, third content 820, fourth content 825, fifth content 830, and sixth content 835 contain content pertaining to the ordered topics from document plan 800, respectively, and the generated content corresponds to an ordering of the topics in the document plan 800. Output document 805 is an example of, or includes aspects of, the corresponding element described with reference to FIGS. 3 and 11.

First content 810 is an example of, or includes aspects of, the corresponding element described with reference to FIG. 11. Second content 815 is an example of, or includes aspects of, the corresponding element described with reference to FIG. 11. Third content 820 is an example of, or includes aspects of, the corresponding element described with reference to FIG. 11. Fourth content 825 is an example of, or includes aspects of, the corresponding element described with reference to FIG. 11. Fifth content 830 is an example of, or includes aspects of, the corresponding element described with reference to FIG. 11. Sixth content 835 is an example of, or includes aspects of, the corresponding element described with reference to FIG. 11.

FIG. 9 shows an example of a machine learning model 900 including an image generator according to aspects of the present disclosure. In one embodiment, machine learning model 900 includes extraction component 905, prompt generation component 910, language generation model 915, and image generator 920. Machine learning model 900 is an example of, or includes aspects of, the corresponding element described with reference to FIGS. 5 and 6.

In an embodiment, machine learning model 900 is used for multi-modal grounded content generation. The input provided is the same as described in the text-grounded content creation framework described in FIG. 6. The retrieved sentences from different source/reference documents and the user-specified intent are input to the prompt generation component 910. The prompt generation component 910 puts together a customized prompt, which is then fed to language generation model 915. Language generation model 915 generates a document plan of the content to be generated, an output document that follows the document plan, and image descriptions that describe or match closely to the generated content. In some examples, a text-to-image generation model (e.g., a diffusion model) generates one or more synthetic images based on the image descriptions.

In an embodiment, reference text and an intent input are input to extraction component 905. Extraction component 905 outputs retrieved content based on the reference text and the intent input. In some cases, extraction component 905 may be referred to as a retrieval model. Extraction component 905 is an example of, or includes aspects of, the corresponding element described with reference to FIGS. 5 and 6.

The retrieved content and a prompt template are input to prompt generation component 910 to obtain a customized prompt. The prompt is used to guide language generation model 915 in grounded document generation. In some examples, the customized prompt includes agent specification, input information, task orientation, constraint implementation, etc. In some examples, machine learning model 900 inserts the intent input and the reference text into the prompt template. The prompt specifies a structure of an output document. In some examples, the prompt includes an instruction not to output a document plan. Prompt generation component 910 is an example of, or includes aspects of, the corresponding element described with reference to FIGS. 5 and 6.

Language generation model 915 generates an image description based on the prompt. Image generator 920 receives the image description as input and generates a synthetic image based on the image description. The image description describes the content of the generated text of the output document. In some cases, images associated with section content represent key topics mentioned in the section content. In addition to the customized prompt described with reference to FIG. 7, the task orientation of the prompt includes instructions to generate image descriptions. For example, the prompt includes a trigger phrase “Give image descriptions that are suitable for the section”. Additionally, to parse the image descriptions, an output format is specified. Language generation model 915 is an example of, or includes aspects of, the corresponding element described with reference to FIGS. 5 and 6.

The image descriptions are then input to a text-to-image generation model (i.e., image generator 920) to obtain a synthetic image. The output document comprises a multi-media document including generated text and the synthetic image (i.e., multi-modal content). Image generator 920 is an example of, or includes aspects of, the corresponding element described with reference to FIG. 5.

In some examples, to address multi-modal document generation, a prompting variant method (referred to as multi-modal plan-and-write) includes generating multi-modal plans with appropriate image descriptions along with textual plans using a language model.

FIG. 10 shows an example of prompt 1000 customization according to aspects of the present disclosure. The example shown includes prompt 1000, first section 1005, second section 1010, third section 1015, fourth section 1020, and fifth section 1025. Prompt 1000 is an example of, or includes aspects of, the corresponding element described with reference to FIG. 7.

First section 1005 relates to agent specification which provides guidelines and directives for the language generation model 915 (described with reference to FIG. 9) to assume a friendly, expert and helpful character. The aim of this character is to aid a user in crafting a systematically structured section for an output document.

Second section 1010 relates to input information which indicates that a document title, section heading(s) and initial context are provided to set the ground for the section, and a selection of reference sentences for generating section content are fed to language generation model 915.

Third section 1015 relates to task orientation which indicates that an objective of language generation model 915 is delineated in a two-fold process. First, language generation model 915 is tasked to formulate a document plan for the section to be generated, illustrating various topics to be the subject of generated content. The document plan serves as a directive for structuring the section. Second, language generation model 915 is prompted to compose the section by using the pre-established document plan and integrating sentences from the reference text. In some cases, the document plan (an intermediate output) is not displayed to users.

Third section 1015 (task orientation) includes instructions to generate image descriptions. Third section 1015 includes a trigger phrase “Give image descriptions that are suitable for the section” such that language generation model 915 (e.g., GPT) can generate image descriptions.

Fourth section 1020 relates to constraint implementation. The prompt layout imposes certain restrictions, for example, the generated content needs to comply with a pre-determined word count range, language generation model 615 needs to rely strictly on the provided reference sentences and refrain from relying on the model's own knowledge. The agent (or the model) is instructed to generate exclusively the final content for the segment, avoiding any surplus output. In some examples, a trigger phrase in prompt 1000 for content generation is, for example, “come up with a plan with various topics to be discussed to write a section on [section name].”

Fifth section 1025 relates to output format specification. To parse the image descriptions, fifth section 1025 of prompt 1000 specifies an output format.

First section 1005 is an example of, or includes aspects of, the corresponding element described with reference to FIG. 7. Second section 1010 is an example of, or includes aspects of, the corresponding element described with reference to FIG. 7. Third section 1015 is an example of, or includes aspects of, the corresponding element described with reference to FIG. 7. Fourth section 1020 is an example of, or includes aspects of, the corresponding element described with reference to FIG. 7.

FIG. 11 shows an example of a document plan 1100 and an output document 1105 according to aspects of the present disclosure. The example shown includes document plan 1100, output document 1105, and image description 1140.

In an embodiment, language generation model 915 (described with reference to FIG. 9) generates document plan 1100 and output document 1105. The document plan 1100 includes a list of topics to be covered and elaborated on in output document 1105. The output document 1105 includes content corresponding to each topic in the list of topics.

For example, document plan 1100 relates to Virginia state symbols and includes “state seal”, “state motto”, “state flag”, “state nicknames”, “state songs”, and “state animals”. Output document 1105 includes content corresponding to each topic in the list of topics following an ordering of the topics or topic descriptions in the list. That is, language generation model 915 expands on the list of topics to obtain content corresponding to each topic. Document plan 1100 is an example of, or includes aspects of, the corresponding element described with reference to FIG. 8.

In an example, output document 1105 includes first content 1110, second content 1115, third content 1120, fourth content 1125, fifth content 1130, and sixth content 1135. First content 1110, second content 1115, third content 1120, fourth content 1125, fifth content 1130, and sixth content 1135 contain content pertaining to the ordered topics from document plan 1100, respectively, and the generated content corresponds to an ordering of the topics in the document plan 1100. Output document 1105 is an example of, or includes aspects of, the corresponding element described with reference to FIGS. 3 and 8.

In an embodiment, language generation model 915 generates image description 1140. Image description 1140 is then fed to a text-to-image generation model to generate a synthetic image. For example, image description 1140 includes “1. Bronze rendering of Virginia's state seal at the Virginia Museum of Fine Arts”, “2. Rendering of Virginia state seal at Capital Square in Richmond, VA”, and “3. Virginia Quarter”. The image description 1140 is input to the text-to-image generation model to generate a synthetic image related to the image description.

First content 1110 is an example of, or includes aspects of, the corresponding element described with reference to FIG. 8. Second content 1115 is an example of, or includes aspects of, the corresponding element described with reference to FIG. 8. Third content 1120 is an example of, or includes aspects of, the corresponding element described with reference to FIG. 8. Fourth content 1125 is an example of, or includes aspects of, the corresponding element described with reference to FIG. 8. Fifth content 1130 is an example of, or includes aspects of, the corresponding element described with reference to FIG. 8. Sixth content 1135 is an example of, or includes aspects of, the corresponding element described with reference to FIG. 8.

FIG. 12 shows an example of a transformer network according to aspects of the present disclosure. The example shown includes transformer 1200, encoder 1205, decoder 1220, input 1240, input embedding 1245, input positional encoding 1250, previous output 1255, previous output embedding 1260, previous output positional encoding 1265, and output 1270.

In some cases, encoder 1205 includes multi-head self-attention sublayer 1210 and feed-forward network sublayer 1215. In some cases, decoder 1220 includes first multi-head self-attention sublayer 1225, second multi-head self-attention sublayer 1230, and feed-forward network sublayer 1235.

According to some aspects, a machine learning model (such as the machine learning model described with reference to FIGS. 5-6 and 9) comprises transformer 1200. In some cases, encoder 1205 is configured to map input 1240 (for example, a query or a prompt comprising a sequence of words or tokens) to a sequence of continuous representations that are fed into decoder 1220. In some cases, decoder 1220 generates output 1270 (e.g., a prediction of an output sequence of words or tokens) based on the output of encoder 1205 and previous output 1255 (e.g., a previously predicted output sequence), which allows for the use of autoregression.

For example, in some cases, encoder 1205 parses input 1240 into tokens and vectorizes the parsed tokens to obtain input embedding 1245, and adds input positional encoding 1250 (e.g., positional encoding vectors for input 1240 of a same dimension as input embedding 1245) to input embedding 1245. In some cases, input positional encoding 1250 includes information about relative positions of words or tokens in input 1240.

In some cases, encoder 1205 comprises one or more encoding layers (e.g., six encoding layers) that generate contextualized token representations, where each representation corresponds to a token that combines information from other input tokens via self-attention mechanism. In some cases, each encoding layer of encoder 1205 comprises a multi-head self-attention sublayer (e.g., multi-head self-attention sublayer 1210). In some cases, the multi-head self-attention sublayer implements a multi-head self-attention mechanism that receives different linearly projected versions of queries, keys, and values to produce outputs in parallel. In some cases, each encoding layer of encoder 1205 also includes a fully connected feed-forward network sublayer (e.g., feed-forward network sublayer 1215) comprising two linear transformations surrounding a Rectified Linear Unit (ReLU) activation:

$$FFN ( x ) = Re LU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 1240.

In some cases, each sublayer of encoder 1205 is followed by a normalization layer that normalizes a sum computed between a sublayer input x and an output sublayer(x) generated by the sublayer:

$$layernorm ( x + sublayer ( x ) ) \qquad ( 2 )$$

In some cases, encoder 1205 is bidirectional because encoder 1205 attends to each word or token in input 1240 regardless of a position of the word or token in input 1240.

In some cases, decoder 1220 comprises one or more decoding layers (e.g., six decoding layers). In some cases, each decoding layer comprises three sublayers including a first multi-head self-attention sublayer (e.g., first multi-head self-attention sublayer 1225), a second multi-head self-attention sublayer (e.g., second multi-head self-attention sublayer 1230), and a feed-forward network sublayer (e.g., feed-forward network sublayer 1235). In some cases, each sublayer of decoder 1220 is followed by a normalization layer that normalizes a sum computed between a sublayer input x and an output sublayer(x) generated by the sublayer.

In some cases, decoder 1220 generates previous output embedding 1260 of previous output 1255 and adds previous output positional encoding 1265 (e.g., position information for words or tokens in previous output 1255) to previous output embedding 1260. In some cases, each first multi-head self-attention sublayer receives the combination of previous output embedding 1260 and previous output positional encoding 1265 and applies a multi-head self-attention mechanism to the combination. In some cases, for each word in an input sequence, each first multi-head self-attention sublayer of decoder 1220 attends only to words preceding the word in the sequence, and so transformer 1200's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 1205 by receiving a query Q from a previous sublayer of decoder 1220 and a key K and a value V from the output of encoder 1205, allowing decoder 1220 to attend to each word in the input 1240.

In some cases, each feed-forward network sublayer implements a fully connected feed-forward network similar to feed-forward network sublayer 1215. In some cases, the feed-forward network sublayers are followed by a linear transformation and a softmax function to generate a prediction of output 1270 (e.g., a prediction of a next word or token in a sequence of words or tokens). Accordingly, in some cases, transformer 1200 generates a response as described herein based on a predicted sequence of words or tokens.

In FIGS. 5-12, an apparatus and method for natural language processing are described. One or more embodiments of the apparatus and method include at least one processor; at least one memory including instructions executable by the at least one processor; a prompt generation component comprising code stored in the at least one memory and configured to generate a prompt for a language generation model based on an intent input and a reference text, wherein the prompt includes a planning instruction and an output instruction; and the language generation model comprising parameters stored in the at least one memory and configured to generate a document plan based on the planning instruction, and to generate an output document based on the output instruction and the document plan, wherein the output document includes content from the reference text consistent with the intent input.

Some examples of the apparatus and method further include an extraction component configured to extract a plurality of sentences from a plurality of different source documents, wherein the reference text includes the plurality of sentences.

Some examples of the apparatus and method further include a text encoder configured to encode the intent input and the reference text to obtain an intent encoding and a text encoding, respectively. In some examples, the language generation model comprises a transformer network.

Some examples of the apparatus and method further include an image generator configured to generate a synthetic image based on an image description, wherein the output document comprises a multi-media document including the synthetic image.

### Training and Evaluation

FIG. 13 shows an example of a step-by-step procedure for training a machine learning model according to aspects of the present disclosure. FIG. 13 shows a flow diagram depicting an algorithm as a step-by-step procedure 1300 in an example implementation of operations performable for training a machine-learning model. In some embodiments, the procedure 1300 describes an operation of the training component 555 described for configuring the machine learning model 525 as described with reference to FIG. 5. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (1312) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1314) examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore once trained is configured to perform that task based on subsequent data received as an input and processed by the machine-learning model.

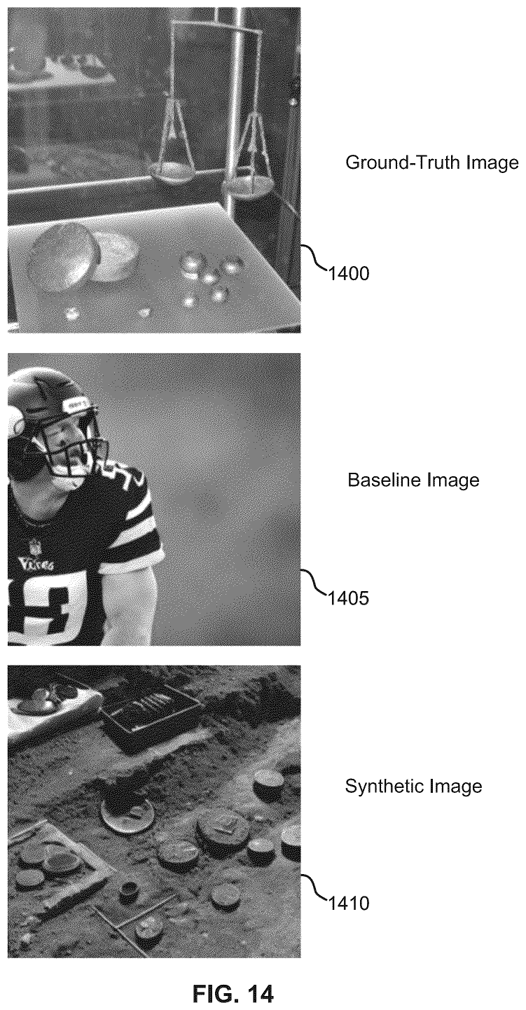

FIG. 14 shows an example of images used during training according to aspects of the present disclosure. The example shown includes ground-truth image 1400, baseline image 1405, and synthetic image 1410.

In an example, an intent input is “Vikings: Trade”. Machine learning model 900 as described in FIG. 9 outputs following section content based on the intent input and reference text (e.g., a Wikipedia article). The generated section content is “The Vikings established and engaged in extensive trading networks throughout the known world and had a profound influence on the economic development of Europe and Scandinavia. Other than in such trading centres as Ribe Hedeby in Denmark, Scandinavia was unfamiliar with the use of coinage, therefore its economy was based on bullion, that is, the purity and weight of precious metals used in exchange. Silver was the precious metal most commonly used, although gold was also used. Traders carried small portable scales, enabling them to measure weight precisely, which allowed an accurate medium of exchange, even lacking a regular coinage.”

Machine learning model 900 generates, using a language generation model, an image description. The image description is then fed to an image generator to obtain synthetic image 1410.

Ground-truth image 1400 is an image associated with the textual content of an article about Viking trade (i.e. trading and weighing precious metals in Scandinavia). Ground-truth image 1400 may be extracted from a Wikipedia article. Baseline image 1405 is generated, using a baseline model, based solely on a text prompt (e.g., “Vikings trade”). “Vikings trade” is an ambiguous term, which may refer to people originally from Scandinavia or an American football team. On the other hand, synthetic image 1410 is generated using machine learning model 900 based on a detailed image description as described with reference to FIGS. 10-11. In comparison to baseline image 1405, synthetic image 1410 includes one or more elements and depicts a scene that are similar to the element(s) and scene of ground-truth image 1400. Synthetic image 1410 is relevant to the article about Vikings trade while baseline image 1405 is about sports (Minnesota Vikings, the football team).

FIG. 15 shows an example of a computing device 1500 for natural language processing according to aspects of the present disclosure. The computing device 1500 may be an example of the text processing apparatus 500 described with reference to FIG. 5. In one aspect, computing device 1500 includes processor(s) 1505, memory subsystem 1510, communication interface 1515, I/O interface 1520, user interface component(s) 1525, and channel 1530.

In some embodiments, computing device 1500 is an example of, or includes aspects of, the machine learning model 525 of FIG. 5. In some embodiments, computing device 1500 includes one or more processors 1505 that can execute instructions stored in memory subsystem 1510 to perform media generation.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

Performance of apparatus, systems and methods of the present disclosure have been evaluated, and results indicate embodiments of the present disclosure have obtained increased performance over conventional technology. Example experiments demonstrate that the text processing apparatus and machine learning model described in embodiments of the present disclosure outperforms conventional systems.

TABLE 1
Sample output of machine learning model 600 (as described with reference to
FIG. 6) and sample output of a GPT baseline model on “Virginia”.

| | |
|---|---|
| ground-truth | Virginia has several nicknames, the oldest of which is the “Old |
| | Dominion.” . . . The state's motto, Sic Semper Tyrannis, translates from |
| | Latin as “Thus Always to Tyrants”, and is used on the state seal, which is |
| | then used on the flag ... In 1940, “Carry Me Back to Old Virginny” was |
| | named the state song, but it was retired in 1997 due to its references to |
| | slavery. In March 2015, Virginia's government named “Our Great |
| | Virginia”, which uses the tune of “Oh Shenandoah”, as the traditional state |
| | song and “Sweet Virginia Breeze” as the popular state song. |
| baseline model | Virginia is home to many state symbols. Virginia's state bird is the |
| | Northern cardinal, which was declared the state bird in 1950. The state's |
| | state flower is the American dogwood, which was designated in 1918. |
| | Virginia's state beverage is milk, while its state fish is the brook trout. |
| | Virginia's state seal is based on a design described in the convention of |
| | 1776 and represents Virtus, the genius of the commonwealth, dressed like |
| | an Amazon, resting on a spear with one hand, and holding a sword in |
| | other, and treading on tyranny, represented by a man prostrate, a crown |
| | fallen from his head, a broken chain in his left hand and a scourge in his |
| | right. The exergon has the word Virginia over Virtus's head and |
| | underneath the motto “Sic Semper Tyrannis”. |
| machine | Virginia is home to a variety of state symbols that reflect its rich history. |
| learning model | One of the most recognizable symbols is the state seal which features |
| 600 (plan-and- | Virtus, . . . The seal also includes the state motto “Sic Semper Tyrannis” |
| write) | which means “Thus Always to Tyrants” . . . The state nickname, “Old |
| | Dominion,” comes from Virginia's historical significance as the first |
| | permanent English colony in the new world and thus representing old |
| | antiquity or a long-standing Custom. Additionally, Virginia has two state |
| | songs, a traditional song, and a popular song that encapsulate the |
| | sentiments of the state. Finally, Virginia also recognizes several state |
| | animals including the Virginia Big-Eared Bat and the northeastern tiger |
| | salamander, and state plants such as the dogwood and American dogwood. |
| | Virginia's state beverage is milk, while its state fish is the brook trout. All |
| | these symbols represent the diverse history, culture, and natural beauty of |
| | Virginia. |

The content in the baseline model and machine learning model outputs that are relevant to the ground truth are highlighted in italic.

Table 1: Sample output of machine learning model 600 (as described with reference to FIG. 6) and sample output of a GPT baseline model on “Virginia”. The content in the baseline model and machine learning model outputs that are relevant to the ground truth are highlighted in italic.

The above qualitative example of text generation about Virginia shows that embodiments of the present disclosure can output higher topical coverage with respect to the ground truth as opposed to that of the baseline (as indicated by the phrases in italic that overlap with the ground truth).

The machine learning model 525 (with reference to FIG. 5) and prompting methods described in the present disclosure are zero-shot, and are not dependent on any parallel training data, and instead rely to accurately instructing a language model such as GPT-3.5 to generate coherent content and appropriate image information using intermediate planning. For evaluation, a few linguistically motivated heuristics based on XML structure and Bing search are implemented to curate a small test set of Wikipedia articles from the Web. Using this data, it has been shown that the planning-based prompting strategy for document generation leads to improved performance than language models such as LLaMa (by ˜2 points Rouge precision, ˜16 points Rouge recall, and ˜13 points Rouge F1 score), and GPT-3.5 (by ˜16 points Rouge recall and 2.5 points Rouge F1 score).

For multi-modal document generation (with text and image in the documents), it has been shown that image relevance using multi-modal plan-and-write prompting is significantly better than using the intent to generate images separately using LLaMa (by ˜5 points ClipScore) and GPT-3.5 (by ˜9 points ClipScore).

In some embodiments, machine learning model 525 (as described in FIG. 5) can automatically generate multi-modal documents (e.g., section content with images) based on a given intent (e.g., section titles) and grounded on one or more reference documents. Machine learning model 525 is not dependent on any parallel training data, and instead leverages a language model (e.g., GPT-3.5, LLaMa) using customized prompting methods.

The plan-and-write prompting method involves taking the document title, section title, and one or more relevant reference sentences as inputs. Language generation model 545 (as described in FIG. 5) generates a plan for the document section, and then generates a coherent section based on the generated plan.

The multi-modal plan-and-write prompting method involves taking the document title, section title, and one or more relevant reference sentences as inputs. Language generation model 545 generates a multi-modal plan including textual topics and image description for the document section, and then uses the plan to generate a coherent section and corresponding images.

Some example experiments implement heuristics to synthetically curate a small test dataset by leveraging the XML tag structure of articles and images in Wikidump, CLIP embedding scores to map images to specific sections to obtain approximate parallel text-image data, and Bing search API to obtain reference links (as external sources). CLIP is short for contrastive language-image pre-training.

Machine learning model 525 automatically generates multi-modal content from user-provided intent and external source documents, without any other user prompts or inputs. Machine learning model 525 automatically infers plans (in the form of the topics and image descriptions) to guide the generation to be in a coherent manner.

Machine learning model 525 enables grounded document generation where the document lengths range beyond single sentences. Machine learning model 525 automatically retrieves the relevant content from the given references based on the intent, while language generation model 545 generates intermediate plans to filter out the useful content from the retrieved sentences to generate coherent final section.

Machine learning model 525 is not dependent on any parallel training data to generate high-quality and coherent generations for given user intent and external reference articles. Machine learning model 525 leverages large language models to automatically generate intermediate plans to guide the generation based on the given intent and references. Machine learning model 525 enables generation of multi-modal content comprising text and images.

In terms of the alignment of the generation with the given intent (section title), plan-and-write outputs are marked better than the baseline in 85% cases; for topical coverage with respect to ground truth, 90% plan-and-write outputs are rated better than the baseline outputs, and for well-formedness of the outputs, 80% plan-and-write outputs are rated better. In some cases, plan-and-write method is described in FIGS. 6-8.

For image relevance with respect to the ground truth images, 85% multi-modal plan-and-write based generations are rated to be more appropriate than the baseline images, demonstrating effectiveness of multi-modal document generation based on given intent and references. In some cases, multi-modal plan-and-write method is described in FIGS. 9-11.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an intent input including a request for information and a reference text including a source for the information;
generating a planning instruction and an output instruction based on the intent input, wherein the planning instruction describes a document structure and an output instruction describes an output from a language generation model;
generating, using the language generation model, a document plan for an output document with the document structure based on the planning instruction; and
generating, using the language generation model, the output document based on the reference text, the output instruction, and the document plan, wherein the output document includes content from the reference text consistent with the intent input.

2. The method of claim 1, wherein:
the intent input comprises a document title, a section heading, or both.

3. The method of claim 1, wherein:
the reference text includes a plurality of sentences from a plurality of different source documents.

4. The method of claim 1, wherein obtaining the reference text comprises:
encoding the intent input and the reference text to obtain an intent encoding and a text encoding, respectively; and
comparing the intent encoding and the text encoding, wherein the reference text is selected based on the comparison.

5. The method of claim 1, wherein generating the prompt comprises:
obtaining a prompt template; and
inserting the intent input and the reference text into the prompt template.

6. The method of claim 1, wherein:
the prompt specifies a structure of the output document.

7. The method of claim 1, wherein:
the prompt includes an instruction not to output the document plan.

8. The method of claim 1, wherein:
the document plan includes a list of topics and the output document includes content corresponding to each topic in the list of topics.

9. The method of claim 1, wherein generating the output document comprises:
autoregressively generating text of the output document.

10. The method of claim 1, further comprising:
generating, using the language generation model, an image description based on the prompt; and
obtaining an image based on the image description, wherein the output document comprises a multi-media document including the image.

11. The method of claim 1, wherein generating the output document comprises:
obtaining a document template; and
inserting the content into the document template.

12. A non-transitory computer readable medium storing code for natural language processing, the code comprising instructions executable by at least one processor to:
obtain an intent input including a request for information and a reference text including a source for the information;
generate a planning instruction and an output instruction based on the intent input, wherein the planning instruction describes a document structure and an output instruction describes an output from a language generation model;
generate, using the language generation model, a document plan for an output document with the document structure based on the planning instruction; and
generate, using the language generation model, the output document based on the reference text, the output instruction, and the document plan, wherein the output document includes content from the reference text consistent with the intent input.

13. The non-transitory computer readable medium of claim 12, the code further comprising instructions executable by the at least one processor to:
encode the intent input and the reference text to obtain an intent encoding and a text encoding, respectively; and
compare the intent encoding and the text encoding, wherein the reference text is selected based on the comparison.

14. The non-transitory computer readable medium of claim 12, the code further comprising instructions executable by the at least one processor to:
obtain a prompt template; and
insert the intent input and the reference text into the prompt template.

15. The non-transitory computer readable medium of claim 12, the code further comprising instructions executable by the at least one processor to:
generate, using the language generation model, an image description based on the prompt; and
obtain an image based on the image description, wherein the output document comprises a multi-media document including the image.

16. An apparatus comprising:
at least one processor;
at least one memory including instructions executable by the at least one processor;
a prompt generation component comprising code stored in the at least one memory and configured to generate a planning instruction and an output instruction based on an intent input, wherein the planning instruction describes a document structure and an output instruction describes an output from a language generation model; and
the language generation model comprising parameters stored in the at least one memory and configured to generate a document plan for an output document with the document structure based on the planning instruction, and to generate the output document based on the reference text, the output instruction, and the document plan, wherein the output document includes content from the reference text consistent with the intent input.

17. The apparatus of claim 16, further comprising:
an extraction component configured to extract a plurality of sentences from a plurality of different source documents, wherein the reference text includes the plurality of sentences.

18. The apparatus of claim 16, further comprising:
a text encoder configured to encode the intent input and the reference text to obtain an intent encoding and a text encoding, respectively.

19. The apparatus of claim 16, wherein:
the language generation model comprises a transformer network.

20. The apparatus of claim 16, further comprising:
an image generator configured to generate a synthetic image based on an image description, wherein the output document comprises a multi-media document including the synthetic image.
